(19) United States
(12) Patent Application Publication
(10) Pub. No.: US 2025/0260134 A1
(43) Pub. Date: Aug. 14, 2025

(54) BUSBAR, BATTERY PACK, AND ELECTRONIC DEVICE

(71) Applicant: EVE POWER CO., LTD., Jingmen (CN)

(72) Inventors: Lei WANG, Jingmen (CN); Yanyan LI, Jingmen (CN); Guojiang ZHANG, Jingmen (CN)

(73) Assignee: EVE POWER CO., LTD., Jingmen (CN)

(21) Appl. No.: 19/195,724

(22) Filed: Apr. 30, 2025

Related U.S. Application Data
(63) Continuation of application No. PCT/CN2022/143092, filed on Dec. 29, 2022.

(30) Foreign Application Priority Data
Nov. 3, 2022 (CN) 202222923249.2

(51) Int. Cl. H01M 50/503; H01M 50/249; H01M 50/517; H01M 50/522; H01M 50/526; H01M 50/588

(52) U.S. Cl. CPC H01M 50/503; H01M 50/517; H01M 50/522; H01M 50/526; H01M 50/588; H01M 50/249

(57) ABSTRACT

A busbar, a battery pack, and an electronic device are provided. The busbar includes an aluminum bar and two copper sleeves, and a mounting hole is provided in each of the two ends of the aluminum bar. The two copper sleeves are secured in one-to-one correspondence in the two mounting holes, and the copper sleeves are electrically connected to the aluminum bar. One of the two copper sleeves is configured for electrically connecting to a battery module, and the other copper sleeve is configured for electrically connecting to an external device.

### CROSS-REFERENCE TO RELATED APPLICATION

This application is a Bypass Continuation Application of PCT/CN2022/143092 filed on Dec. 29, 2022, which claims priority to Chinese Patent Application No. 202222923249.2, filed on Nov. 3, 2022, the entire content of the application is incorporated herein by reference.

### TECHNICAL FIELD

The present application relates to the technical field of batteries, and more particularly, to a busbar, a battery pack, and an electronic device.

### DESCRIPTION OF RELATED ART

Currently used power battery packs all include multiple battery modules. The electrical connection between adjacent battery modules, or between the battery module and the power output section of the battery pack, is facilitated through a busbar. The busbars in the related art are mainly copper bars, and some busbars also use a wire harness with a welded terminal structure.

Copper bars, also known as copper busbars or copper busbars, are made of copper and function to transmit current and connect electrical equipment in circuits. Power busbars are capable of carrying large currents and are used in high and low voltage electrical appliances, switch contacts, power distribution equipment, bus ducts, and other electrical engineering. Copper bars have the advantages such as low resistivity and large bendability. However, power battery packs require a relatively large number of copper bars. Because copper bars are made of copper or copper alloys, their individual weight and manufacturing costs are high, which impedes the lightweight development of new energy vehicles and also keeps the manufacturing costs of new energy vehicles elevated.

Therefore, there is an urgent need to improve the conventional technology to address the technical problems existing in the busbars of the related art.

### SUMMARY OF INVENTION

In a first aspect, this application introduces a busbar designed to reduce both its weight and the costs associated with raw materials and production without compromising its conductive performance.

The present application employs the following solutions.

The busbar includes an aluminum bar and two copper sleeves. Each of two ends of the aluminum bar is provided with a mounting hole. The two copper sleeves are fixed in the two mounting holes in a one-to-one correspondence. The copper sleeves are electrically connected to the aluminum bar. One of the two copper sleeves is configured for electrically connecting to a battery module, and the other copper sleeve (120) is configured for electrically connecting to an external device.

In one embodiment, the copper sleeve is provided with a connection hole, the copper sleeve is connected to the battery module or the external device through a bolt, and the bolt is inserted through the connection hole.

In one embodiment, two end faces of the copper sleeve in the vertical direction extend out of the mounting hole.

In one embodiment, an area of an upper end face of the copper sleeve is not less than an area of a lower end face of a head flange of the bolt.

In one embodiment, the connection hole of one of the two copper sleeves is an elongated hole.

In one embodiment, the copper sleeve is friction welded and fixed in the mounting hole.

In one embodiment, an outer surface of the aluminum bar is electroplated with a protective layer.

In one embodiment, an outer surface of the aluminum bar is covered with an insulation layer.

In one embodiment, the aluminum bar is formed by bending an aluminum plate, and two ends of the aluminum bar are provided with round chamfers.

In a second aspect, the present application provides a battery pack. The battery pack includes multiple battery modules and the busbar according to any one of the above solutions. The busbar is arranged between two adjacent ones of the battery modules or between the battery module and an output end of the battery pack.

In a third aspect, the present application provides an electronic device. The electronic device includes the battery pack in the aforementioned solution.

### BENEFICIAL EFFECTS

The busbar in this application, by fixing the two copper sleeves in the two mounting holes of the aluminum bar respectively, enables the copper sleeves to be electrically connected to the aluminum bar. One of the copper sleeves is used for electrical connection to the battery module, and the other copper sleeve is used for electrical connection to an external device. Utilizing the excellent conductivity of the copper sleeves enables effective current conduction from the battery module. Furthermore, the main body of the busbar is an aluminum bar, which not only offers superb conductivity and ease of processing, but also has the advantages of low density and low material cost. By replacing the copper bar in the original busbar with an aluminum bar, the present application can significantly decrease both the weight and manufacturing costs of the busbar without compromising its conductive performance.

### BRIEF DESCRIPTION OF DRAWINGS

FIG. 1 is a schematic view of a busbar provided by one embodiment of the present application.

FIG. 2 is a schematic view of the busbar installed on a battery module according to one embodiment of the present application.

In the drawings:

100: busbar; 110: aluminum bar; 111: mounting hole; 112: insulation layer; 120: copper sleeve; 121: connection hole; 210: bolt; 211: head flange; 220: end plate; 230: CCS assembly.

### DETAILED DESCRIPTION OF EMBODIMENTS OF THE INVENTION

In the description of the present application, unless explicitly specified and defined otherwise, the terms “connected”, “connection”, and “fixed” shall be interpreted broadly. For example, it may be a fixed connection, or a detachable connection, or integrated; it may be a mechanical connection, or an electrical connection; it may be a direct connection, or an indirect connection through an intermediate medium. It may also be internal communication or the interaction between two elements. Those of ordinary skill in the art can understand the specific meaning of the above terms in the present application on a case-by-case basis.

In this application, unless specifically limited otherwise, the terminology “on” or “below” when referring to the first feature relative to the second feature can imply that both features are either in direct contact or indirectly connected via an intermediary component. Furthermore, when a feature is described as “above”, “over”, or “on” another feature, it includes scenarios where the first feature is directly or obliquely positioned above the second feature, or it simply may indicate that the first feature is at a higher horizontal level. Similarly, terms like “below”, “under”, and “beneath” indicate that the first feature could be directly or obliquely below the second feature, or just at a lower horizontal level than the second feature.

In this description of the embodiments, terms such as “up”, “down”, “right”, and other directional or positional terms are based on the orientations shown in the drawings. These are used solely for ease of description and to simplify the explanation, not to suggest that the devices or components must be configured or operated in a specific orientation. Thus, such terms should not be seen as limiting the scope of this application. Additionally, the use of “first” and “second” in this text serves merely to differentiate between elements and does not imply any special meaning.

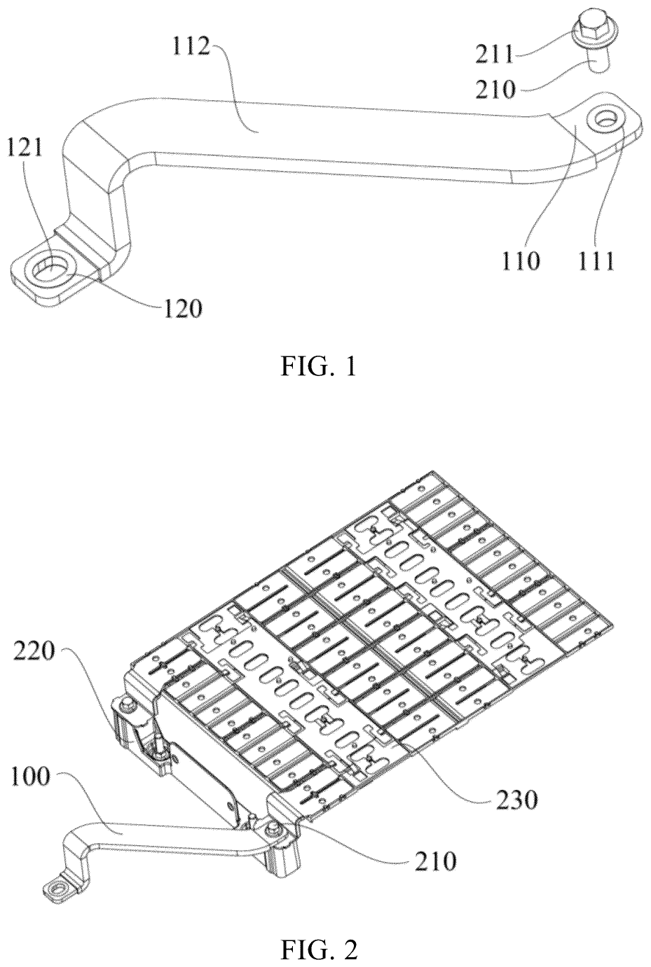

Please refer to FIG. 1. In this embodiment, the busbar 100 includes an aluminum bar 110 and two copper sleeves 120. The aluminum bar 110 is provided with a mounting hole 111 at either end. The two copper sleeves 120 are fixed in the two mounting holes 111 in a one-to-one correspondence. The copper sleeves 120 are electrically connected to the aluminum bar 110. One of the two copper sleeves 120 is used to electrically connect to a battery module, and the other copper sleeve 120 is used to electrically connect to an external device. The external device mentioned here includes another battery module, an output end of the battery pack that incorporates the battery module, or other electronic equipment. Those skilled in the art can use the busbar 100 to electrically connect the battery module to other external devices according to specific needs, and no specific limitation is made here.

The busbar 100 in this embodiment, by fixing the two copper sleeves 120 in the two mounting holes 111 of the aluminum bar 110 respectively, enables the copper sleeves 120 to be electrically connected to the aluminum bar 110, and one of the copper sleeves 120 is used to electrically connect to the battery module, and the other copper sleeve 120 is used to electrically connect to an external device. The copper sleeves 120 utilize their conductivity to efficiently conduct the current from the battery module. The main component of the busbar 100 is the aluminum bar 110, which not only offers excellent conductivity and ease of processing but is also advantageous due to aluminum's low density and low material costs. By substituting the aluminum bar 110 for the copper bar in the original busbar design, the weight and manufacturing costs of the busbar 100 are significantly reduced, without compromising the conductivity of the busbar 100.

Please continue to refer to FIG. 1. In this embodiment, the copper sleeve 120 is provided with a connection hole 121. The copper sleeve 120 is connected to the battery module or the external device through a bolt 210. The bolt 210 is inserted through the connection hole 121. The busbar 100 connected by the bolt 210 is easy to install and disassemble, enhancing both the reliability and stability of the connection, thus ensuring that the busbar 100 does not detach from the battery module.

Optionally, one of the two copper sleeves 120 includes the connection hole 121 as an elongated hole. In this embodiment, the connection hole 121 of the copper sleeve 120 connected to the external device is an elongated hole. The elongated hole is also called a long round hole, and its shape includes semi-circular arcs at both ends with a parallel plane in the middle. This elongated hole design simplifies the alignment and positioning processes during the machining of the connection holes 121 and the installation of the copper sleeves. This configuration also facilitates the adjustment of component positions. It is merely to make a width of the middle plane of the elongated hole less than a diameter of a head flange 211 of the bolt 210.

Further, both end faces of the copper sleeve 120 in the vertical direction protrude from the mounting hole 111. In this embodiment, when the copper sleeve 120 is fixed in the mounting hole 111, the upper end face of the copper sleeve 120 extends out of the mounting hole 111, and the lower end face of the copper sleeve 120 also extends out of the mounting hole 111, so that the copper sleeve 120 can fully contact the head flange 211 of the bolt 210 and the battery module or external device, ensuring that the electrical connection between the copper sleeve 120 and the battery module or external device is not affected, leading to enhanced stability of both the current and voltage.

In one example embodiment, an area of the upper end face of the copper sleeve 120 is not less than an area of the lower end face of the head flange 211 of the bolt 210. The copper sleeve 120 configured in this way can ensure that when the bolt 210 is tightened, the head flange 211 achieves full contact with the copper sleeve 120, and exerts sufficient compressive force to the copper sleeve 120 to secure the copper sleeve 120 to the battery module or external device. This configuration enhances the stability of the electrical connection, resulting in enhanced stability of the current and voltage.

Specifically, the copper sleeve 120 is friction welded and fixed in the mounting hole 111. Friction welding refers to a method of connecting thermoplastic materials by using the frictional heat generated by the mutual friction between them to melt the friction surfaces, and then pressurizing and cooling them. Friction welding not only offers the benefits typical of hot-pressure welding but also ensures a high-quality, stable connection. It provides high dimensional and geometric accuracy of the welded parts, reduces manufacturing costs, improves welding efficiency, and is more environmentally friendly.

Further, an outer surface of the aluminum bar 110 is electroplated with a protective layer. The protective layer is formed by electroplating, which can protect the connection between the aluminum bar 110 and the copper sleeve 120 after welding, prevent the connection from being corroded and damaged, and improve the service life and reliability of the busbar 100.

In an example, the outer surface of the aluminum bar 110 is covered with an insulation layer 112. Specifically, the insulation layer 112 is formed by a dip-coating insulating process. The insulation layer 112 can ensure that once the busbar 100 is installed, it does not come into contact with another busbar 100 or any other live electrical equipment. This prevents short circuits and enhances the safety of the busbar 100.

In one embodiment, the aluminum bar 110 is formed by bending an aluminum plate, and the aluminum bar 110 is provided with round chamfers at both ends. Specifically, in this embodiment, the aluminum bar 110 is shaped from an aluminum plate measuring 1000 mm in length, 20 mm in width, and 3 mm in thickness, using a 3D bending process. There are no specific limitations on this process. When bending the aluminum plate directly, the four corners of the plate tend to be relatively sharp. Therefore, applying rounded chamfers to both ends of the aluminum bar 110 helps prevent the occurrence of tip discharge, thus enhancing the safety of the busbar 100.

Please continue to refer to FIG. 2. FIG. 2 shows a schematic view of the busbar 100 installed on a battery module. FIG. 2 shows an end plate 220 and a CCS assembly 230 of the battery module. The busbar 100 is fixed on the end plate 220 by the bolt 210 and is electrically connected to the CCS assembly 230. This embodiment further provides a battery pack, which includes multiple battery modules and the busbar 100 according to any of the above solutions. The busbar 100 is arranged between two adjacent battery modules or between the battery module and an output end of the battery pack. The battery pack using the busbar 100 in the above solution not only has a greatly reduced overall weight but also reduces production costs.

This embodiment also provides an electronic device. The electronic device includes the battery pack according to the above solution. Specifically, the electronic device described in this embodiment is a car. The car using the above battery pack achieves a reduced weight of the car, which in turn enhances the driving range and lowers the overall cost of the vehicle.

What is claimed is:

1. A busbar, comprising:
an aluminum bar, wherein each of two ends of the aluminum bar is provided with a mounting hole; and
two copper sleeves, wherein the two copper sleeves are fixed in the two mounting holes in a one-to-one correspondence, the copper sleeves are electrically connected to the aluminum bar; and
one of the two copper sleeves is electrically connected to a battery module, and the other copper sleeve is electrically connected to an external device.

2. The busbar according to claim 1, wherein the copper sleeve is provided with a connection hole, the copper sleeve is connected to the battery module or the external device through a bolt, and the bolt is inserted through the connection hole.

3. The busbar according to claim 2, wherein two end faces of the copper sleeve extend vertically out of the mounting hole.

4. The busbar according to claim 2, wherein an area of an upper end face of the copper sleeve is not less than an area of a lower end face of a head flange of the bolt.

5. The busbar according to claim 2, wherein the connection hole of one of the two copper sleeves is an elongated hole.

6. The busbar according to claim 1, wherein the copper sleeve is friction welded and fixed in the mounting hole.

7. The busbar according to claim 6, wherein an outer surface of the aluminum bar is electroplated with a protective layer.

8. The busbar according to claim 1, wherein an outer surface of the aluminum bar is covered with an insulation layer.

9. The busbar according to claim 1, wherein the aluminum bar is a bent aluminum plate, and two ends of the aluminum bar are provided with round chamfers.

10. A battery pack, comprising multiple battery modules and a busbar, wherein the busbar is arranged between two adjacent ones of the battery modules or between the battery module and an output end of the battery pack, and the busbar comprises:
an aluminum bar, wherein each of two ends of the aluminum bar is provided with a mounting hole; and
two copper sleeves, wherein the two copper sleeves are fixed in the two mounting holes in a one-to-one correspondence, the copper sleeves are electrically connected to the aluminum bar; and
one of the two copper sleeves is electrically connected to a battery module, and the other copper sleeve is electrically connected to an external device.

11. The busbar according to claim 10, wherein the copper sleeve is provided with a connection hole, the copper sleeve is connected to the battery module or the external device through a bolt, and the bolt is inserted through the connection hole.

12. The busbar according to claim 11, wherein two end faces of the copper sleeve extend vertically out of the mounting hole.

13. The busbar according to claim 11, wherein an area of an upper end face of the copper sleeve is not less than an area of a lower end face of a head flange of the bolt.

14. The busbar according to claim 11, wherein the connection hole of one of the two copper sleeves is an elongated hole.

15. The busbar according to claim 10, wherein the copper sleeve is friction welded and fixed in the mounting hole.

16. The busbar according to claim 15, wherein an outer surface of the aluminum bar is electroplated with a protective layer.

17. The busbar according to claim 10, wherein an outer surface of the aluminum bar is covered with an insulation layer.

18. The busbar according to claim 10, wherein the aluminum bar is a bent aluminum plate, and two ends of the aluminum bar are provided with round chamfers.

19. An electronic device, comprising a battery pack, the battery pack comprising multiple battery modules and a busbar, wherein the busbar is arranged between two adjacent ones of the battery modules or between the battery module and an output end of the battery pack, and the busbar comprises:
an aluminum bar, wherein each of two ends of the aluminum bar is provided with a mounting hole; and
two copper sleeves, wherein the two copper sleeves are fixed in the two mounting holes in a one-to-one correspondence, the copper sleeves are electrically connected to the aluminum bar; and
one of the two copper sleeves is electrically connected to a battery module, and the other copper sleeve is electrically connected to an external device.

20. The electronic device according to claim 19, wherein the electronic device is a car, an automobile or an electric vehicle.
